(19) United States
(12) Patent Application Publication
(10) Pub. No.: US 2025/0104446 A1
(43) Pub. Date: Mar. 27, 2025

(54) METHODS AND SYSTEMS FOR TRACKING ROADWAY LANE MARKINGS

(71) Applicant: Woven by Toyota, Inc., Tokyo (JP)

(72) Inventors: Jan Falkowski, Tokyo (JP); James Biagioni, Tokyo (JP); Daniel Pontillo, Tokyo (JP); Alana Ohno, Tokyo (JP)

(73) Assignee: Woven by Toyota, Inc., Tokyo (JP)

(21) Appl. No.: 18/471,418

(22) Filed: Sep. 21, 2023

(51) Int. Cl. G06V 20/56; B60W 30/18; G01C 21/00; G06V 10/22; G06V 10/26; G06V 10/62; G08G 1/16

(52) U.S. Cl. CPC G06V 20/588; B60W 30/18163; G06V 10/225; G06V 10/235; G06V 10/26; G06V 10/62; G08G 1/167; B60W 2420/403; B60W 2552/30; B60W 2552/53; G01C 21/3815

(57) ABSTRACT

The present disclosure is directed to methods and systems for tracking roadway lane markings. The method includes collecting a frame of image data of the roadway, separating a first individual lane marking from among the first frame of image data of the roadway, assigning an identifier to the separated individual lane marking, and comparing the first separated individual lane marking to a subsequent frame of image data of the roadway.

### FIELD

The present disclosure relates to methods and systems for tracking roadway lane markings.

### TECHNICAL BACKGROUND

Roadways may have lane markings, such as lane lines and dashed lane-dividers. Vehicle assistance systems such as lane keep assistance systems and autonomous vehicles may use a forward facing image collection device to collect images of the lane markings to navigate vehicles through curves and turns in the roadways. It may be useful for these systems to determine that a lane marking detected in a first frame is the same lane line detected in a subsequent frame in order to track a lane line over a distance traveled. Conventional lane marking tracking systems may involve large amounts of computational power to identifying the lane markings in an image and track the lane markings between frames.

### SUMMARY

Roadway lane markings may be tracked by autonomous or semi-autonomous vehicles to determine the location of the vehicle relative to the roadway lanes, keep the vehicle within the roadway lane such as with lane keep assist systems, perform lane-change maneuvers between multiple lanes, and/or other various features. Present systems may require large amounts of computing power to determine the location of roadway lane markings. Further, present systems may examine entire frames of roadway image data and not focus specifically on the lane markings within the frame of roadway image data. Therefore, there exists a need for a roadway lane marking detection and tracking system which may use less computational power than conventional systems and methods.

The present method can more efficiently track roadway lane markings than conventional roadway lane markings methods and systems by using less computing power.

The system generally includes a processor, an image collection device, an artificial intelligence device, and a vehicle controller. The processor, image collection device, artificial intelligence device, and vehicle controller may be connected to one another, such as through a wired connection or a wireless network. One or more of the processor, image collection device, artificial intelligence device, and/or vehicle controller may be arranged on a vehicle. The processor may process a frame of forward-facing image data of a roadway to isolate roadway lane markings.

According to one embodiment, a method for detecting roadway lane markings includes collecting a frame of image data of the roadway, separating a first individual lane marking from among the first frame of image data of the roadway, assigning an identifier to the separated individual lane marking, and comparing the first separated individual lane marking to a subsequent frame of image data of the roadway.

According to another embodiment, a vehicle navigation system, includes a vehicle, an image collection device arranged on the vehicle, a processor, and a vehicle controller, wherein the image collection device, the processor, and the vehicle controller are connected to one another via a network, and wherein the processor receives input data from the image collection device, separates lane markings within the input data, and transmits an output to the vehicle controller to control the vehicle.

Additional features and advantages of the technology described in this disclosure will be set forth in the detailed description which follows, and in part will be readily apparent to those skilled in the art from the description or recognized by practicing the technology as described in this disclosure, including the detailed description which follows, the claims, as well as the appended drawings.

### BRIEF DESCRIPTION OF THE DRAWINGS

The following detailed description of the present disclosure may be better understood when read in conjunction with the following drawings in which:

FIG. 1 schematically depicts a view of a network of devices for performing a method, according to one or more embodiments shown and described herein;

FIG. 2 schematically depicts a view of identified roadway markings in a frame of image collection device data, according to one or more embodiments shown and described herein;

FIG. 3 schematically depicts a determined angle of an identified roadway marking in a frame of image collection device data, according to one or more embodiments shown and described herein;

FIG. 4 schematically depicts a flowchart of a method according to one or more embodiments shown and described herein; and

FIG. 5 schematically depicts a flowchart of a method according to one or more embodiments shown and described herein.

Reference will now be made in greater detail to various embodiments of the present disclosure, some embodiments of which are illustrated in the accompanying drawings. Whenever possible, the same reference numerals will be used throughout the drawings to refer to the same or similar parts.

### DETAILED DESCRIPTION

Embodiments of the present disclosure are directed to methods and systems for tracking roadway lane markings. The method may include capturing a frame of roadway image data with an image collection device, such as a camera. A system may automatically isolate a lane marking in the frame of roadway image data. The system may then separate individual pixels in the frame of roadway image data which form a roadway marking, such as a lane line. The system may then assign a unique identifier to the isolated pixels. The system may then compare the identified isolated pixels to a subsequent frame of image data of the roadway. In other embodiments, the system may be used to navigate a vehicle. An image collection device, processor, and vehicle controller are all connected to one another via a network. The image collection device may provide an input to the processor. The processor may transmit outputs to the vehicle controller for controlling the vehicle.

Conventional roadway marking detection methods and systems may require a large amount of computing power to detect and track roadway markings between frames of roadway data. For example, conventional methods and systems may process entire frames of roadway image data, rather than isolating only the portion of the frames of roadway image data that contains roadway markings. Embodiments can improve roadway marking detection methods and systems by isolating the pixels containing roadway markings in the frames of roadway image data and only processing these small portions of the frames of roadway image data.

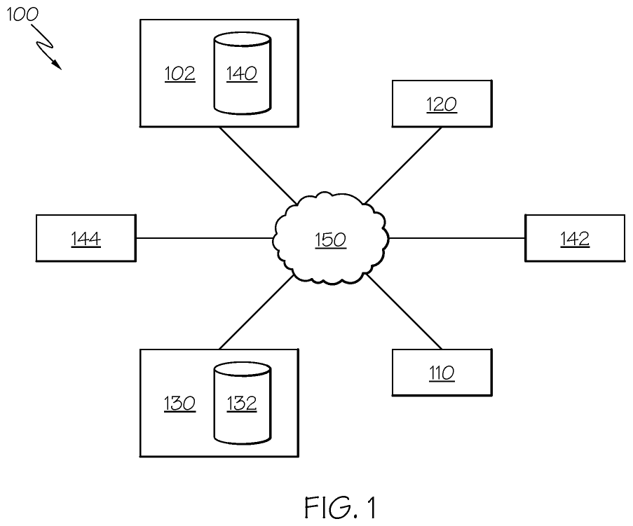

Referring now to FIG. 1, an example of a system 100 for tracking roadway lane markings is shown consistent with a disclosed embodiment. As shown in FIG. 1, a vehicle 102, a processor 110, an image collection device 120, an artificial intelligence device 130, a user interface 142, and a map device 144 are communicatively coupled to one another via a network 150. Although a specific numbers of processors 110, image collection devices 120, artificial intelligence devices 130, vehicle controllers 140, user interfaces 142, and map devices 144 are depicted in FIG. 1, any number of these devices may be provided. Furthermore, the functions provided by one or more devices of system 100 may be combined and the functionality of any one or more components of system 100 may be implemented by any appropriate computing environment.

Network 150 facilitates communications between the various devices in system 100, such as the vehicle 102, the processor 110, the image collection device 120, the artificial intelligence device 130, the user interface 142, and map device 144. Network 150 may be a shared, public, or private network, may encompass a wide area or local area, and may be implemented through any suitable combination of wired and/or wireless communication networks. Furthermore, network 150 may include a local area network (LAN), a wide area network (WAN), an intranet, or the Internet. The network 150 may allow for near-real time communication between devices connected over the network.

In embodiments, the vehicle 102 may be an autonomous or semi-autonomous vehicle. In other embodiments, the vehicle 102 may have a lane keep assist system which may assist a user of the vehicle 102 in maintaining the vehicle 102 within a lane of a roadway.

The vehicle 102 may be an autonomous or semi-autonomous vehicle. In other embodiments, the vehicle 102 may have a lane keep assist system which may assist a user of the vehicle 102 in maintaining the vehicle 102 within a lane of a roadway. The vehicle 102 may have a vehicle controller 140. The vehicle controller 140 may be a computing device for controlling the vehicle 102. In embodiments where the vehicle 102 is an autonomous vehicle, the vehicle controller 140 may control all aspects of the movement of the vehicle 102, including but not limited to acceleration, braking, and steering, such that the system 100 may autonomously control the vehicle based upon detected lane markings. In embodiments where the vehicle 102 is not an autonomous vehicle, the vehicle controller 140 may supplement the acceleration, braking, and steering inputs of an operator.

Processor 110 may include a non-transitory, processor-readable storage medium for storing program modules that, when executed by a processor, perform one or more processes described herein. The non-transitory, processor-readable storage medium may be one or more memory devices that store data as well as software and may also comprise, for example, one or more of RAM, ROM, magnetic storage, or optical storage. Since disclosed embodiments may be implemented using an HTTPS (hypertext transfer protocol secure) environment, data transfer over a network, such as the Internet, may be done in a secure fashion.

Image collection device 120 may be a camera or other suitable device for capturing images. The image collection device 120 may be oriented so as to collect forward facing image data from a roadway 158. In one embodiment, the image collection device 120 may collect a first frame of roadway data 160 and subsequent frames of roadway data.

The artificial intelligence device 130 may be a device which houses an artificial intelligence model 132. The artificial intelligence model 132 may be a feature recognition algorithm.

User interface 142 may be a device for a user to select options or interact with the system 100. In embodiments, the user interface 142 may be a mobile computing device, a tablet, a computer, or any other suitable type of user interface. In other embodiments, the user interface 142 may be integrated into an infotainment system of the vehicle 102, such as an infotainment touchscreen or control knob.

Map device 144 may be a device which stores maps of roadways. The map device 144 may download maps onto memory associated with the map device 144, access maps from a map database, or have access to maps from any other suitable source.

In embodiments, the processor 110 receives input data from the image collection device 120, processes the input data, and transmits an output to the vehicle controller 140. In further embodiments, the processor 110 may receive inputs from the user interface 142. In yet further embodiments, the processor 110 may be supplemented by the artificial intelligence model 132 stored on the artificial intelligence device 130.

In embodiments, one or more of the processor 110, the image collection device 120, the artificial intelligence device 130, the user interface 142, and/or the map device 144 may be physically arranged on the vehicle 102.

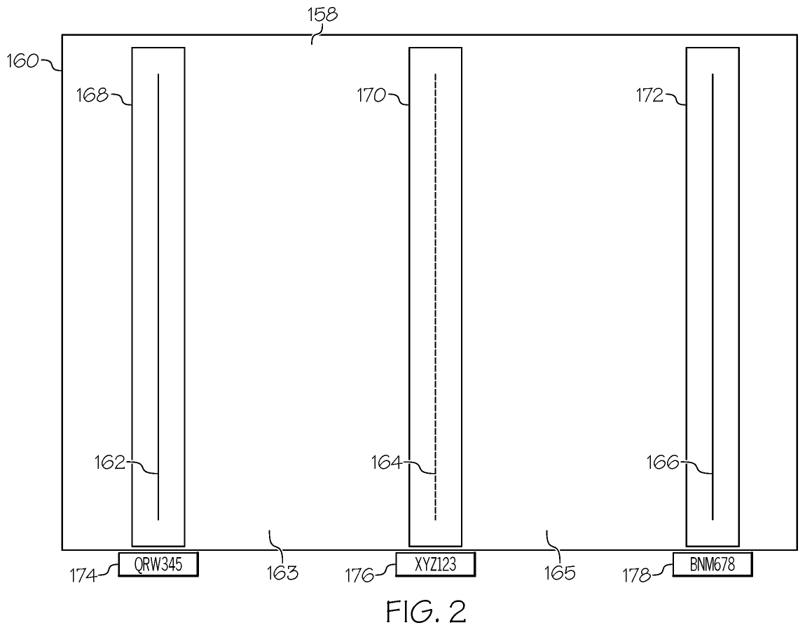

Referring now to FIG. 2, an illustration of the operation of the system 100 is shown consistent with a disclosed embodiment. The system 100 may capture a first frame of roadway data 160. The first frame of roadway data may be a photograph of a roadway at a first position. The roadway 158 may be a highway, a surface street, or other surfaces upon which the vehicle 102 may traverse. The roadway 158 may include one or more lane markings indicating a division between lanes of the roadway 158, the outer bounds of the roadway 158, or other possible roadway features.

The first frame of roadway data 160 may include, for example, a first lane marking 162, a second lane marking 164, and a third lane marking 166. In other embodiments, the first frame of roadway data 160 may include any suitable number of lane markings, such as one lane marking, two lane markings, five lane markings, ten lane markings, or any other suitable number of lane markings. While the first lane marking 162 and the third lane marking 166 are shown as solid lines and the second lane marking 164, it should be understood that the roadway 158 may include any variation of solid or dashed roadway markings.

The first frame of roadway data 160 may be constructed of a plurality of pixels. Each of the plurality of pixels may display a unique data point of the first frame of roadway data 160. The system 100 may isolate the pixels from the first frame of roadway data 160 which display the first lane marking 162, the second lane marking 164, and/or the third lane marking 166. The system 100 may define a first lane of the roadway 163 between the first lane marking 162 and the second lane marking 164, and a second lane of the roadway 165 between the second lane marking 164 and the third lane marking 166. The system 100 may use any suitable process to isolate the pixels, such as by the artificial intelligence model 132 being trained as an image recognition model. In other embodiments, a user may manually isolate the pixels with the user interface 142, such as by manually selecting pixels or drawing a shape around a group of pixels in order to isolate those pixels.

The system 100 may place a first bounding box 168 around the first lane marking 162. The first bounding box 168 may identify the first lane marking 162 within the first frame of roadway data 160. While the first bounding box 168 is referred to as a “box,” it should be understood that any suitable shape may be placed around the first lane marking 162, including but not limited to a circle, an oval, or a rectangle. A first identifier 174 may be associated with the first bounding box 168. The first identifier 174 may be a unique string of characters to identify the first lane marking 162 from various other lane markings. While the first identifier 174 is illustrated as a string of alphanumeric characters, it should be understood that any unique identifier may be used, including but not limited to a shape, a color, or any other suitable identifier.

The system 100 may similarly place a second bounding box 170 around the second lane marking 164 and a second identifier 176 may be associated with the second bounding box 170. The system 100 may also place a third bounding box 172 around the third lane marking 166 and a third identifier 178 may be associated with the third bounding box 172.

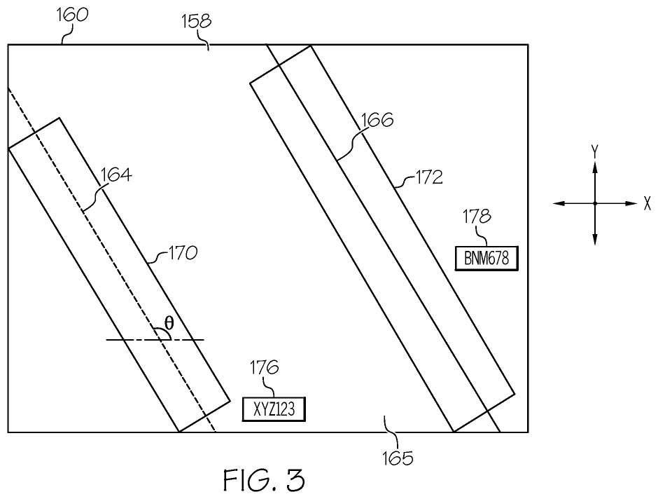

Referring now to FIG. 3, an illustration of the operation of the system 100 is shown consistent with a disclosed embodiment. The first frame of roadway data 160 may include the second lane marking 164, the second bounding box 170, and the second identifier 176. The system 100 may determine a first angle Θ of the second lane marking 164 relative to a horizontal axis X. The first angle Θ may be stored by the system 100. It should be understood that in embodiments, the first angle Θ may be determined relative to any other suitable axis, such as the vertical axis Y.

The system 100 may repeat the identification of the one or more roadway markings with a subsequent second frame of roadway data. The second frame of roadway data may be captured by the image collection device 120 at a later time than the first frame of roadway data 160 (e.g., 1 second later). Thus, the vehicle 102 may have moved between the capturing of the first frame of roadway data 160 and the capturing of the second frame of roadway data, which may change the orientation of the second frame of roadway data with respect to the image collection device.

In embodiments, the system 100 may isolate the pixels forming the various roadway markings of the second frame of roadway data, place bounding boxes around the isolated roadway markings in the second frame of roadway data, and determine a second angle of the roadway marking relative to an axis in the second frame of roadway data. The system 100 may compare the second angle from the second frame of roadway data with the determined first angle Θ of the first frame of roadway data 160. If the first angle Θ and the second angle are within a predetermined range of one another, the system 100 may determine that the second lane marking 164 in the first frame of roadway data 160 is the same lane marking isolated in the second frame of roadway image data. That is, the system 100 may determine that because the first angle Θ is equal or nearly equal to second angle, the second lane marking 164 isolated in the first frame of roadway data 160 is the same lane marking along the roadway 158 in the second frame of roadway data. In embodiments, the predetermined range may be the first angle Θ and the second angle are within 5 degrees of one another, within 1 degree of one another, within 0.1 degrees of one another, within 0.01 degrees of one another, or any other suitable range.

The trajectory of the vehicle 102 may be tracked, such as by an accelerometer associated with the vehicle 102. In some embodiments, the system 100 may consider the trajectory of the vehicle 102 and change in orientation of the vehicle 102 relative to the lane markings between the first frame of roadway data 160 and the second frame of roadway data. As a non-limiting example, if the accelerometer indicates the vehicle 102 is making a left-hand turn between the capturing of the first frame of roadway data 160 and the second frame of roadway data, the system 100 may expect the second angle of the isolated lane marking relative to the horizontal x-axis to be less than the first angle Θ.

The locating of the vehicle 102 may be tracked, such as by a GPS device associated with the vehicle 102. In some embodiments, the system 100 may compare the location of the vehicle 102, the identified lane markings, and a map on the map device 144. The system 100 may add the location of the identified lane markings to the map on the map device 144.

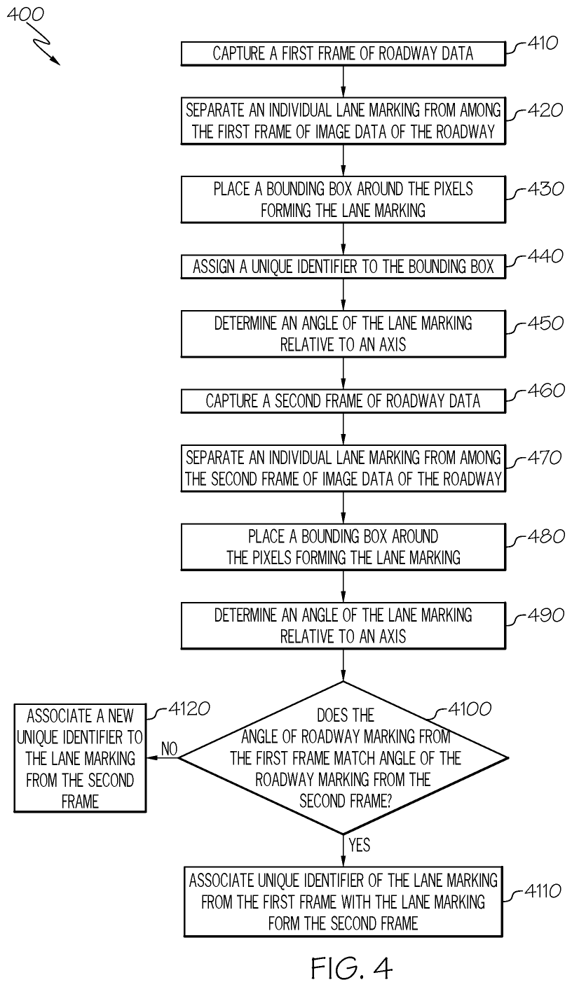

Referring now to FIG. 4, a method 400 is illustrated consistent with a disclosed embodiment. The method 400 is directed towards tracking roadway markings. At step 410, the method 400 includes capturing a first frame of roadway data 160. That is, the image collection device 120 may capture a frame of the roadway 158.

At step 420, the method 400 includes separating an individual lane marking from among the first frame of image data of the roadway. That is, the artificial intelligence device 130, a user utilizing the user interface 142, or any other suitable device capable of separating individual lane markings may separate the lane marking from the first frame of roadway data 160.

At step 430, the method 400 includes placing a bounding box around the pixels forming the lane marking. That is, the system 100 may place a shape around the lane marking to identify the lane marking within the first frame of roadway data 160.

At step 440, the method 400 includes assigning a unique identifier to the bounding box. That is, the system 100 may assign a unique identifier, such as a string of alphanumeric characters, a shape, or a color, to the bounding box in order to distinguish the bounding box and isolated lane marking from other bounding boxes and isolated lane markings.

At step 450, the method 400 includes determining an angle of the lane marking relative to the axis. That is, the system 100 may measure the angle of the lane marking relative to a horizontal axis, a vertical axis, or any other suitable axis.

At step 460, the method 400 includes capturing a second frame of roadway data. That is, the image collection device 120 may capture a frame of the roadway 158 at a time after the first frame of roadway data is captured.

At step 470, the method 400 includes separating an individual lane marking from among the second frame of image data of the roadway. That is, the artificial intelligence device 130, a user utilizing the user interface 142, or any other suitable device capable of separating individual lane markings may separate the lane marking from the second frame of roadway data.

includes isolating the pixels of the second frame of roadway data which form a lane marking. That is, the artificial intelligence device 130, a user utilizing the user interface 142, or any other device capable of isolating pixels may isolate the pixels that make up the lane marking from the second frame of roadway data.

At step 480, the method 400 includes placing a bounding box around the pixels forming the lane marking from the second frame of roadway data. That is, the system 100 may place a shape around the lane marking to identify the lane marking within the second frame of roadway data.

At step 490, the method 400 includes determining an angle of the lane marking relative to the axis in the second frame of roadway data. That is, the system 100 may measure the angle of the lane marking in the second frame of roadway data relative to a horizontal axis, a vertical axis, or any other suitable axis. The axis used to measure the angle of the roadway marking from the first frame of roadway data 160 should be the same axis used to measure the angle of the roadway marking from the second frame of roadway data.

At step 4100, the method 400 includes determining if the angle of the roadway marking from the first frame of roadway data 160 matches the angle of the roadway marking from the second frame of roadway data. That is, the system 100 may compare the angle of the lane marking from the first frame of roadway data 160 to the angle of the lane marking from the second frame of roadway data. If the angle of the lane marking from the first frame of roadway data 160 is within a predetermined threshold range from the angle of the lane marking from the second frame of roadway data, the method proceeds to step 4110. If the angle of the lane marking from the first frame of roadway data 160 is not within the predetermined threshold range from the angle of the lane marking from the second frame of roadway data, the method proceeds to step 4120.

At step 4110, the method 400 includes associating the unique identifier associated with the lane marking in the first frame of roadway data 160 with the lane marking in the second frame of roadway data. That is, the system 100 may determine that the lane marking in the first frame of roadway data 160 is the same lane marking as the lane marking in the second frame of roadway data, and therefore keep the same unique identifier between multiple frames of roadway data.

At step 4120, the method 400 includes associating a new unique identifier with the lane marking in the second frame of roadway data. That is, the system 100 may determine that roadway marking in the second frame of roadway data is a different lane marking than the lane marking in the first frame of roadway data 160, and therefore a new unique identifier should be associated with the roadway marking in the second frame of roadway data.

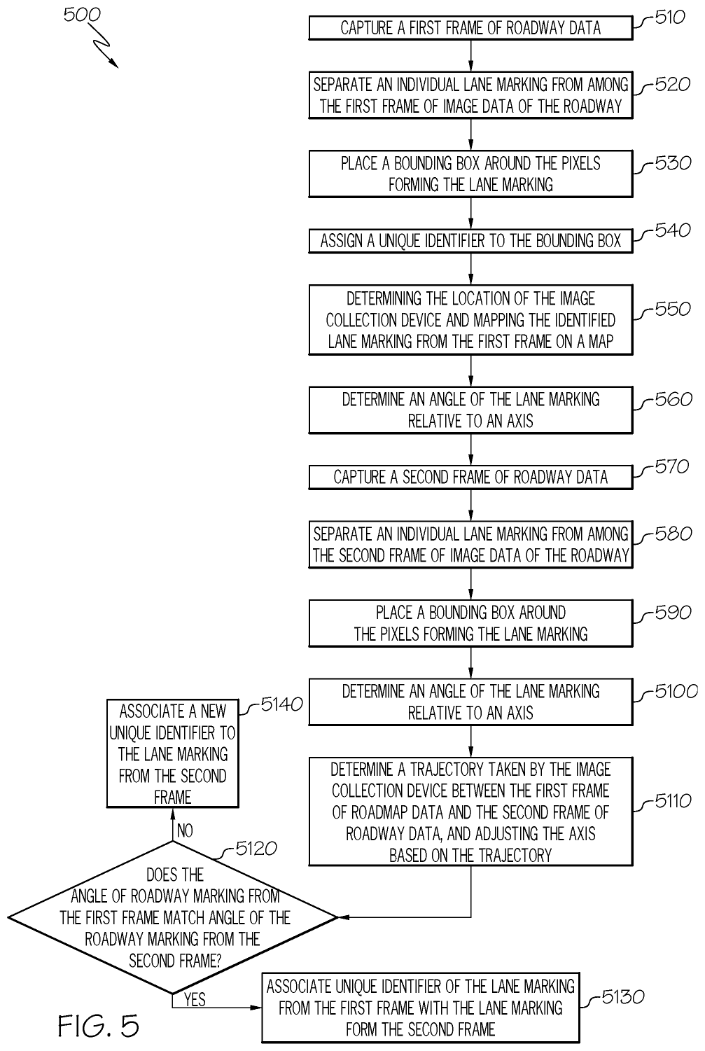

Referring now to FIG. 5, a method 500 is illustrated consistent with a disclosed embodiment. The method 500 is directed towards tracking roadway markings. At step 510, the method 500 includes capturing a first frame of roadway data 160. That is, the image collection device 120 may capture a frame of the roadway 158.

At step 520, the method 500 includes separating an individual lane marking from among the first frame of image data of the roadway. That is, the artificial intelligence device 130, a user utilizing the user interface 142, or any other suitable device capable of separating individual lane markings may separate the lane marking from the first frame of roadway data 160.

At step 530, the method 500 includes placing a bounding box around the pixels forming the lane marking. That is, the system 100 may place a shape around the lane marking to identify the lane marking within the first frame of roadway data 160.

At step 540, the method 500 includes assigning a unique identifier to the bounding box. That is, the system 100 may assign a unique identifier, such as a string of alphanumeric characters, a shape, or a color, to the bounding box in order to distinguish the bounding box and isolated lane marking from other bounding boxes and isolated lane markings.

At step 550, the method 500 includes determining the location of the image collection device 120 and mapping the identified lane marking in the first frame of roadway data 160 on a map housed within the map device 144. In embodiments, the image collection device 120 may be associated with the vehicle 102, and the vehicle 102 may have a GPS device associated therewith.

At step 560, the method 500 includes determining an angle of the lane marking relative to an axis. That is, the system 100 may measure the angle of the lane marking relative to a horizontal axis, a vertical axis, or any other suitable axis.

At step 570, the method 500 includes capturing a second frame of roadway data. That is, the image collection device 120 may capture a frame of the roadway 158 at a time after the image collection device 120 captures the first frame of roadway data 160.

At step 580, the method 500 includes separating an individual lane marking from among the second frame of image data of the roadway. That is, the artificial intelligence device 130, a user utilizing the user interface 142, or any other suitable device capable of separating individual lane markings may separate the lane marking from the second frame of roadway data.

the method 500 includes isolating the pixels of the second frame of roadway data which form a lane marking. That is, the artificial intelligence device 130, a user utilizing the user interface 142, or any other device capable of isolating pixels may isolate the pixels that make up the lane marking from the second frame of roadway data.

At step 590, the method 500 includes placing a bounding box around the pixels forming the lane marking from the second frame of roadway data. That is, the system 100 may place a shape around the lane marking to identify the lane marking within the second frame of roadway data.

At step S100, the method 500 includes determining an angle of the lane marking relative to an axis. That is, the system 100 may measure the angle of the lane marking relative to a horizontal axis, a vertical axis, or any other suitable axis. The axis used to measure the angle of the roadway marking from the first frame of roadway data 160 should be the same axis used to measure the angle of the roadway marking from the second frame of roadway data.

At step S110, the method 500 includes determining the trajectory taken by the image collection device 120 between the first frame of roadway data 160 and the second frame of roadway data, and adjusting the axis based on the trajectory taken by the image collection device 120. That is, if the trajectory taken by the image collection device 120 veers to the left between the first frame of roadway data 160 and the second frame of roadway data, the system 100 may adjust the axis to compensate for the change in orientation of the image collection device 120 between the first frame of roadway data 160 and the second frame of roadway data.

At step S120, the method 500 includes determining if the angle of the roadway marking from the first frame of roadway data 160 matches the angle of the roadway marking from the second frame of roadway data. That is, the system 100 may compare the angle of the lane marking from the first frame of roadway data 160 to the angle of the lane marking from the second frame of roadway data. If the angle of the lane marking from the first frame of roadway data 160 matches the angle of the lane marking from the second frame of roadway data, the method proceeds to step S130. If the angle of the lane marking from the first frame of roadway data 160 does not match the angle of the lane marking from the second frame of roadway data, the method proceeds to step S140.

At step S130, the method 500 includes associating the unique identifier associated with the lane marking in the first frame of roadway data 160 with the lane marking in the second frame of roadway data. That is, the system 100 may determine that the lane marking in the first frame of roadway data 160 is the same lane marking as the lane marking in the second frame of roadway data, and therefore keep the same unique identifier between multiple frames of roadway data.

At step S140, the method 500 includes associating a new unique identifier with the lane marking in the second frame of roadway data. That is, the system 100 may determine that roadway marking in the second frame of roadway data is a different lane marking than the lane marking in the first frame of roadway data 160, and therefore a new unique identifier should be associated with the roadway marking in the second frame of roadway data.

Accordingly embodiments of the present disclosure provide methods and systems for more effectively and efficiently tracking a roadway lane marking, and for using the tracked roadway lane marking to navigate a vehicle. Particularly, the methods and systems may isolate the pixels comprising the roadway lane marking from the frames of roadway image data to limit the amount of computing power needed to track the lane markings between frames of roadway image data. In embodiments, the system may be used to navigate a vehicle, such that the vehicle tracks the identified roadway markings along the roadway in order to follow the curvature of the roadway, perform a lane change maneuver, or otherwise be navigated.

It may be noted that one or more of the following claims utilize the terms “where,” “wherein,” or “in which” as transitional phrases. For the purposes of defining the present technology, it may be noted that these terms are introduced in the claims as an open-ended transitional phrase that are used to introduce a recitation of a series of characteristics of the structure and should be interpreted in like manner as the more commonly used open-ended preamble term “comprising.”

It should be understood that any two quantitative values assigned to a property may constitute a range of that property, and all combinations of ranges formed from all stated quantitative values of a given property are contemplated in this disclosure.

Having described the subject matter of the present disclosure in detail and by reference to specific embodiments, it may be noted that the various details described in this disclosure should not be taken to imply that these details relate to elements that are essential components of the various embodiments described in this disclosure, even in casings where a particular element may be illustrated in each of the drawings that accompany the present description. Rather, the claims appended hereto should be taken as the sole representation of the breadth of the present disclosure and the corresponding scope of the various embodiments described in this disclosure. Further, it will be apparent that modifications and variations are possible without departing from the scope of the appended claims.

1. A method for detecting roadway lane markings, the method comprising:
collecting a frame of image data of a roadway;
separating a first individual lane marking from among the frame of image data of the roadway;
assigning an identifier to the first separated individual lane marking; and
comparing the first separated individual lane marking to a subsequent frame of image data of the roadway.

2. The method of claim 1, further comprising:
determining an angle of the first separated individual lane marking with respect to an axis; and
comparing the angle of the first separated individual lane marking with respect to the axis to an angle of the first separated individual lane marking with respect to the axis from the subsequent frame of image data of the roadway.

3. The method of claim 1, wherein the step of separating the first individual lane marking from the frame of image data of the roadway is performed by an artificial intelligence model.

4. The method of claim 1, wherein the step of separating the first individual lane marking from the frame of image data of the roadway is performed on a user interface.

5. The method of claim 1, further comprising using the first separated individual lane marking to navigate a vehicle.

6. The method of claim 1, further comprising mapping the first separated individual lane marking onto a map.

7. The method of claim 1, further comprising:
separating a second individual lane marking from among the frame of image data of the roadway; and
defining a first lane of the roadway between the first separated individual lane marking and the second separated individual lane marking.

8. The method of claim 7, further comprising:
separating a third individual lane marking from among the frame of image data of the roadway; and
defining a second lane of the roadway between the second separated individual lane marking and the third separated individual lane marking.

9. The method of claim 1, wherein the step of collecting the frame of image data of the roadway is performed by a forward facing camera of a vehicle.

10. The method of claim 9, further comprising the differences between the frame of image data of the roadway and the subsequent frame of image data of the roadway is corrected for a vehicle trajectory.

11. The method of claim 1, wherein the step of isolating a separated individual lane marking from the frame of roadway image data further comprises placing a bounding box around the isolated lane marking.

12. The method of claim 11, wherein the step of isolating a lane marking from the frame of roadway image data and placing the bounding box around the isolated lane marking further comprises associating a unique identifier with the bounding box.

13. A vehicle navigation system, the system comprising:
a vehicle;
an image collection device arranged on the vehicle;
a processor; and
a vehicle controller;
wherein the image collection device, the processor, and the vehicle controller are connected to one another via a network, and wherein the processor may receive input data from the image collection device, separate lane markings within the input data, and transmit an output to the vehicle controller to control the vehicle.

14. The vehicle navigation system of claim 13, further comprising an artificial intelligence device, wherein the artificial intelligence device is connected to the image collection device, the processor, and the vehicle controller through the network.

15. The vehicle navigation system of claim 14, wherein the artificial intelligence device stores an artificial intelligence model, the artificial intelligence model configured to separate individual lane markings of the roadway data.

16. The vehicle navigation system of claim 13, wherein the output transmitted from the processor causes the vehicle controller to control the vehicle to follow a curvature in a roadway.

17. The vehicle navigation system of claim 16, wherein the output transmitted from the processor tracks one or more separated roadway lane markings.

18. The vehicle navigation system of claim 13, wherein the output transmitted from the processor causes the vehicle controller to control the vehicle to execute a lane change maneuver.

19. The vehicle navigation system of claim 13, further comprising a user interface communicatively coupled to the vehicle navigation system.

20. The vehicle navigation system of claim 19, wherein the user interface is configured to allow a user to isolate pixels of roadway data comprising a lane marking.
